(19) United States
(12) Patent Application Publication
(10) Pub. No.: US 2017/0139740 A1
(43) Pub. Date: May 18, 2017

(54) Systems and Methods for Real Time Context Based Isolation and Virtualization

(71) Applicant: Futurewei Technologies, Inc., Plano, TX (US)

(72) Inventors: Lee Dobson McFearin, Plano, TX (US); Alan Gatherer, Richardson, TX (US); Yan Bei, Shanghai (CN)

(73) Assignee: FUTUREWEI TECHNOLOGIES, INC., Plano, TX (US)

(21) Appl. No.: 14/939,662

(22) Filed: Nov. 12, 2015

(51) Int. Cl. G06F 9/46; G06F 9/54

(52) U.S. Cl. CPC G06F 9/466; G06F 9/54

(57) ABSTRACT

An embodiment method includes receiving, by an intellectual property (IP) block within a computing system, a transaction request and determining, by the IP block, a context corresponding to the transaction request. The method further includes determining, by the IP block, a view of the computing system defined by the context and processing, by the IP block, the transaction request in accordance with the view of the computing system defined by the context.

### TECHNICAL FIELD

The present invention relates generally to managing the allocation of resources in a network, and in particular embodiments, to techniques and mechanisms for systems and methods for real time context based isolation and virtualization.

### BACKGROUND

A typical semiconductor device, such as a transceiver device, includes various interconnected hardware components to provide various functional processes, such as, transmission, reception, despreading, decoding, Fast Fourier Transforms (FFTs), signal measurements, Multiple Input Multiple Output (MIMO) operations, direct memory access (DMA) operations, memory-related operations, and the like. Multiple hardware components (sometimes referred to as intellectual property (IP) blocks) may be involved in the execution of each process. For example, each process may include one or more threads, which are executed by one or more IP blocks in the device. Fault isolation and virtualization of different processes are desirable for efficient management of system resources.

Timesharing systems may be implemented on some devices. While such timesharing systems may provide good isolation and virtualization among different processes, timesharing systems generally cannot guarantee real-time constraints and typically only work on homogeneous systems (e.g., systems with one type of processor). In contrast, many embedded systems are heterogeneous systems (e.g., systems having more than one type of processor) that can provide real-time guarantees. However, isolation and virtualization of processes on embedded systems is limited.

### SUMMARY OF THE INVENTION

Technical advantages are generally achieved, by embodiments of this disclosure which describe systems and methods for real time context based isolation and virtualization.

In accordance with an embodiment, a method includes receiving, by an intellectual property (IP) block within a computing system, a transaction request and determining, by the IP block, a context corresponding to the transaction request. The method further includes determining, by the IP block, a view of the computing system defined by the context and processing, by the IP block, the transaction request in accordance with the view of the computing system defined by the context.

In accordance with another embodiment, an intellection property (IP) block includes processing circuitry and a computer readable storage medium storing programming for execution by the processing circuitry. The programming including instructions to receive a transaction request, receive a context identifier (ID) of a context corresponding to the transaction request, determine a system view defined by the context, and process the transaction request in accordance with the system view defined by the context.

In accordance with yet another embodiment, a method includes receiving, by a controller in a computing system, a service request including a thread and determining, by the controller, a context for the thread. The method further includes configuring, by the controller, a view of the computing system by the context on a respective context table at each of a plurality of intellectual property (IP) blocks in the computing system. After configuring, by the controller, the view of the computing system defined by the context, a service corresponding to the service request is initiated.

In accordance with yet another embodiment, a controller includes a processor and a computer readable storage medium storing programming for execution by the processor. The programming including instructions to receive a service request including a thread, determine a context for the thread, configure a system view defined by the context on a respective context table at each of a plurality of intellectual property (IP) blocks, and after configuring the system view defined by the context, initiate a service corresponding to the service request.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram of an embodiment system;

FIGS. 2A and 2B illustrate block diagrams of contexts and context tables within an embodiment system;

FIGS. 3A and 3B illustrate block diagrams of context operations within an embodiment system;

FIGS. 4A and 4B illustrates example process flow of operations within an embodiment system;

FIG. 5 illustrates simulation data of software effort in an embodiment system;

FIG. 6 illustrates a diagram of an embodiment processing system; and

FIG. 7 illustrates a diagram of an embodiment transceiver.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Various embodiments are described within a specific context, namely isolation and virtualization in a heterogeneous, real-time environment of a transceiver device. However, various embodiment devices may be used in any semiconductor device having different hardware components where isolation and virtualization of processes is desired.

Various embodiments implement contexts within a heterogeneous, real-time environment in order to provide isolation and virtualization of different processes run by a system (e.g., a semiconductor device). A process may include one or more threads, and each thread may run within a pre-defined context. One or more threads may run within a same context. The system may configure these contexts on individual hardware components (referred to as IP blocks), and each context defines what system resources, capabilities, priority, security, and the like are available to threads operating within the context. For example, different IP blocks offer resources and capabilities to threads in accordance with the context of the threads, which an IP block can determine using a context identifier (ID) transmitted with every transaction within the system. Thus, resource management and access permissions may be enforced by individual IP blocks within the system, which provides an efficient, real-time mechanism for visualization and isolation of embedded processing resources.

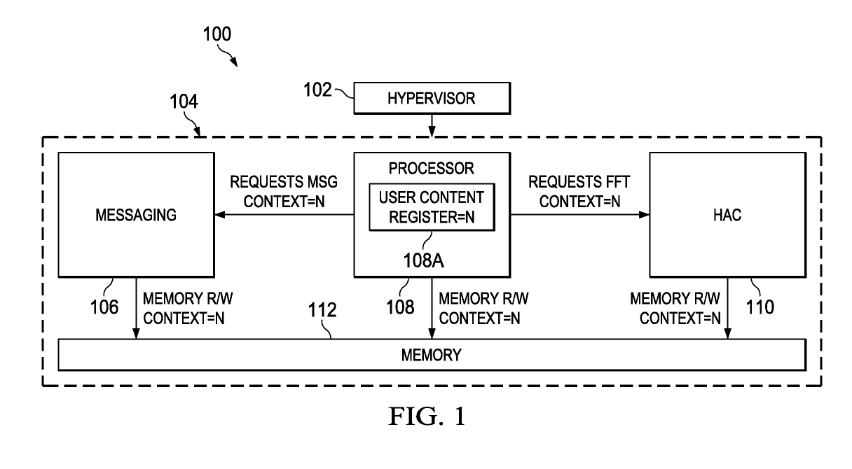

FIG. 1 illustrates a block diagram of a system 100 according to some embodiments. System 100 may be a semiconductor device, such as a transceiver or any kind of computing device. System 100 includes a hypervisor 102, which configures various contexts at individual IP blocks 104 within system 100 as explained in greater detail below. Hypervisor 102 may be a dedicated hardware processor or a virtual machine running on a processor, which may also run other processes. In other embodiments, hypervisor 102 may be replaced with any suitable controller, such as, an operating system running on a processor.

As further illustrated by FIG. 1, system 100 includes IP blocks 104 providing various functionalities within system 100. An IP block may be used to refer to any component within a system that provides a block of functionality to the system. In system 100, IP blocks 104 include a messaging device 106, a processor 108 (e.g., a digital signal processor (DSP), a central processing unit (CPU), combinations thereof, and the like), a hardware accelerator (HAC) 110, and a memory block 112. HAC 110 may be configured to provide any suitable function, such as, MIMO operations, FFT operations, DMA operations, and the like. Each IP block offers resources and capabilities to threads in accordance with a context of the thread as will be explained in greater detail below. The configuration of IP Blocks 104 provided in FIG. 1 is purely for illustrations sake only. Other embodiment systems may include any combination of IP blocks 104 as well as other IP blocks, which may provide the above described functions and/or other functions. Additionally, other embodiment systems may include any number of the illustrated IP blocks. For example, an embodiment system may include five or more processors 108 and multiple memory blocks.

In system 100, hypervisor 102 configures contexts for threads running within system 100 and IP blocks 104. Context configuration may be performed at any time in the system, such as, link time, boot time, runtime, combinations thereof, and the like. In an embodiment, hypervisor 102 receives a service request from a user. The service request may include one or more threads. Hypervisor 102 determines a context of each thread in the service request, and hypervisor 102 also determines whether the relevant contexts (e.g., the contexts of the threads) are configured at IP blocks 104. In some embodiments, contexts for different threads are determined by a system engineer, who is configuring and/or programming the system. For example, the engineering may make a map of possible system operations and divide the operations into different contexts. Once the mapping is complete, hypervisor 102 configures contexts at individual IP blocks according to the mapping.

Each IP block 104 includes a mechanism to support contexts locally. For example, hypervisor 102 may update applicable tables at IP blocks 104 with the resources and capabilities available to threads running within the context (referred to as a thread's view of the system). For example, a thread only sees available system resources/capabilities as defined by the thread's context, and other system resources/capabilities outside of the thread's context are not visible to the thread. Each IP block 104 may define its various views of the system (e.g., context-specific views of the system) and present an applicable view of the system based on a context of a requester (e.g., a context of a thread requesting an operation).

In an embodiment, contexts configured in an IP block's context table remain indefinitely. In another embodiment, contexts in a context table may be periodically cleared or updated depending on system configuration. For example, memory IP blocks' context tables may track access permissions to specific memory locations for each context. These access permissions may change as an application runs, and the memory IP blocks may request buffers/release outdated contexts and/or request updates to contexts at periodic intervals. In another example, proxy IP blocks (e.g., DMA HACs) may pass a context to a controlling IP block, and the proxy IP blocks may not keep any information on contexts between threads. For example, the proxy IP block may clear its context table after a thread is completed. Other context table clearing and/or updating schemes may be implemented in other embodiments. Thus, the management of context tables within each IP block may vary between different of IP blocks (e.g., between different types of IP blocks) depending on system configuration.

After hypervisor 102 determines the relevant context(s) are configured at relevant IP blocks 104, hypervisor 102 initiates the service request by passing the threads and the context of each thread to processor(s) 108. Operating in a supervisor mode, processor 108 then stores the context of the next thread to execute (“n” in FIG. 1) in a user context register 108A. Subsequently processor 108 operates (e.g., processes the thread) in a user mode within context n. In some embodiments, processor 108 only operates within a single context at a time (e.g., only one context is stored at a time within user context register 108A), and processor 108 only processes threads within the context (e.g., multiple threads may run within a same context) at a time. In such embodiments, system 100 may include multiple processors 108, and each processor may operate in a context of a respective thread running on the processor. Because threads may run in different contexts, each processor in the system may also run in a different context. The context that processor 108 operates within may also be changed based on a thread running on processor 108. For example, individual IP blocks determine which thread to run next. A local supervisor for that IP block (e.g. an operating system for a CPU or DSP) can set the operational user context for that thread, for example, as determined by the IP block. The new thread then runs within a corresponding new context, which may be different than the context of a previous thread.

Subsequently, Processor 108 processes the thread by transmitting transaction requests to applicable IP blocks 104, and a context ID (“n” in FIG. 1) is transmitted with each transaction request. For example, FIG. 1 illustrates processor 108 requesting messaging from messaging device 106, memory read/write operations from memory block 112, and FFTs from HAC 110. Upon receiving a transaction request, a receiving IP block 104 (e.g., messaging deice 106, memory block 112, and HAC 110) may process the request in accordance with the thread's context as indicated by the context ID. The receiving IP block may inherit the context from the requestor (e.g., context n from processor 108), and the receiving IP block may further transmit additional transaction requests to other IP blocks 104. These transactions may also be transmitted with the applicable context ID (e.g., the context ID inherited from the requestor). For example, HAC 110 and messaging device 106 may request memory read/write operations from memory 112 and context ID “n” is transmitted with the requests. Each IP block 104 may process a transaction request in accordance with the thread's context as explained in greater detail below.

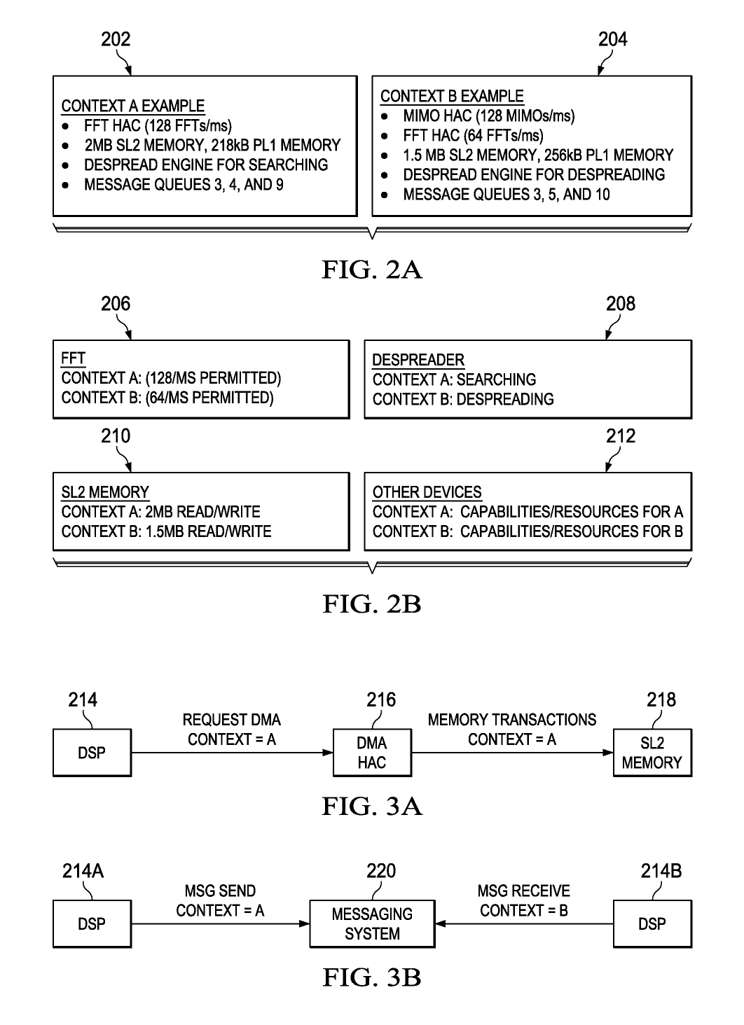

FIG. 2A illustrates example contexts 202 (Context A) and 204 (Context B). In various embodiments, a context defines the system resources and capabilities available to threads operating within the context. For example, a context defines a thread's view of system 100. As illustrated by FIG. 2A, Context A provides threads operating within Context A access to 128 FFTs/millisecond (ms) of FFT HAC resources, 2 megabytes (MB) of shared level 2 (SL2) memory, 128 kilobytes (kB) of private level 1 (PL1) memory, a despread engine for the purpose of searching, and access to message queues 3, 4, and 9. In contrast, Context B provides threads operating within Context B access to 128 MIMO operations/ms of MIMO HAC resources, 64 FFTs/ms of FFT HAC resources, 1.5 MB of SL2 memory, 256 kB of PL1 memory, a despread engine for the purpose of despreading, and access to message queues 3, 5, and 10. Different contexts offer threads access to different capabilities and resources in the system. The resources and capabilities available to threads are enforced at individual IP blocks in accordance with a thread's context as explained in greater detail below. The specific resources and capabilities defined by contexts in FIG. 2A are purely for illustrative sake only. Embodiment contexts may define any combination of system resources and/or capabilities for threads within the context, and any number of contexts may be defined for an embodiment system. Furthermore, while only resources and capabilities are illustrated in FIG. 2A, contexts may also be used to define priority, protection, and/or other system parameters in system 100. For example, IP blocks may be configured to process threads in Context A before processing threads in Context B or to process threads in Context A using a higher level of security features than threads in Context B.

In various embodiments, a controller (e.g., a hypervisor) configures tables at each IP block with the relevant contexts operating within the system. For example, FIG. 2B illustrates example context tables 206, 208, 210, and 212 configured at IP blocks. Context tables 206, 208, 210, and 212 may define available capabilities and resources corresponding to Contexts A and B of FIG. 2A. Context tables at each IP block may include the relevant capabilities and resources for each context pertaining to the specific IP block. For example, context table 206 may be configured at a FFT HAC, which allows the FFT HAC to determine the resources and capabilities available to Context A (e.g., 128 FFTs/ms permitted) and Context B (e.g., 64 FFTs/ms permitted). As another example, context table 208 may be configured at a despreader, which allows the despreader to determine the resources and capabilities available to Context A (e.g., searching permitted) and Context B (e.g., despreading permitted). Context table 210 may be configured at SL2 memory, which allows the SL2 memory to determine the resources and capabilities available to Context A (e.g., 2 MB of Read/Write operations permitted) and Context B (e.g., 1.5 MB of Read/Write operations permitted). Generally, context table 212 may be configured at any other device to show the capabilities and resources available for relevant contexts in the system (e.g., Context A and Context B). New devices may be added into the system by configuring a context table at the new device, and thus, contexts allow for system design flexibility and easy integration of new system components. The specific resources and capabilities defined by context tables in FIG. 2B are for purely illustrative sake only. Embodiment context tables may define any combination of system resources and/or capabilities for any number of contexts in an embodiment system.

In some embodiments, one or more IP block within the system may not include any context tables (e.g., table size zero). In such embodiments, the IP blocks may assume all contexts are permitted and may process requests accordingly. However, the IP blocks may still accept a context ID with each received transaction request and pass along the context ID with each transmission related to the transaction request. For example, although such IP blocks may not change its behavior with different contexts, the IP blocks may still pass along contexts that received at an input to an output.

By configuring context tables at each IP block within the system, individual IP blocks may enforce contexts locally without additional input from a controller (e.g., a hypervisor or an operating system) while the IP block is processing a transaction. In an embodiment, an IP block (e.g., a FFT HAC) receives a transaction request in a supervisor mode (e.g., a local supervisor receives a transaction request). The IP block validates the request based on the context (e.g., as determined by a context ID received with the transaction request). Subsequently, the IP block sets its “user context” to the appropriate context for the request (Context A or Context B) and the IP block performs the requested transaction (e.g., an FFT) in the appropriate context in a user mode. When running in a user mode, the IP block may be prevented from changing its context. This provides isolation and prevents user applications from impersonating other contexts. When the transaction finishes, the IP block transitions back to supervisor mode to determine what thread to run next and repeats the cycle.

For example, FIG. 3A illustrates a block diagram of the execution of a thread in a system after Contexts A and B (see FIG. 2A) are configured on IP blocks (e.g., using context tables, see FIG. 2B). As illustrated by FIG. 3A, a processor (DSP 214) is running a thread in Context A. DSP 214 transmits a DMA request to a DMA HAC 216, and a context ID (e.g., identifying Context A) is transmitted with the DMA request. DMA HAC 216 receives the DMA request and inherits the thread's context from DSP 214. For example, after receiving the request, DMA HAC 216 is also running a thread in Context A.

In an embodiment, DMA HAC 216 acts as a proxy and passes the transaction request and the context ID to a memory device (e.g., SL2 memory 218). SL2 memory 218 determines the resources and capabilities available to threads in Context A and processes the request accordingly. For example, based on context table 210 (see FIG. 2B), SL2 memory 218 determines that Context A provides access to 2 MB of Read/Write memory. In accordance with Context A, SL memory 218 may allow up to 2 MB of Read/Write memory transactions for the memory transaction request. Thus, resource management and capabilities are enforced locally by SL memory 218 without requiring additional resource/permission verification with a controller. However, if the memory transaction requests access to resources/capabilities not available in Context A, SL memory may alert a controller (e.g., a hypervisor) of the invalid access attempt, for example, by transmitting an error. When the controller receives such an error, the controller may determine whether the context table at the IP block is outdated (e.g., whether the thread should have access to the requested capabilities/resources). If the thread should have access to the requested capabilities/resources, the controller updates the table at the IP block accordingly, and the IP block may execute the requested function. If the thread should not have access to the requested capabilities/resources, the controller may determine the thread is faulty and terminate the thread.

In another embodiment, DMA HAC 216 may process the request in accordance with the system capabilities and resources defined by Context A. For example, SL2 memory capabilities and resources of Context A may be known to DMA HAC 216 (e.g., through a table at DMA HAC 216), and DMA HAC 216 may throttle access to SL2 memory 218 for any threads running in a context without the appropriate permissions. In such embodiments, DMA HAC 216 only transmits transaction requests to SL2 memory 218 for threads running in contexts providing the appropriate capabilities/resources. Thus, access to individual IP Blocks 104 can be controlled at any point in the system by configuring context tables at individual IP blocks 104. Generic IP blocks (e.g., DMA HAC 216) may simply pass a thread and corresponding context, or the generic IP blocks may control access to subsequent IP blocks.

In some embodiments, a messaging system 220 may be used to change a context of data as illustrated by FIG. 3B. For example, a first DSP 214A is running a thread in context A, and DSP 214A transmits a message send request to messaging system 220. Messaging system 220 verifies the message transmission is in Context A and a message reception should be in context B. Messaging system 220 may then transfer the context of the message to context B, for example, by sending the message through a static message channel. In an embodiment, the message channel is configured in hardware to provide static message channels between contexts. In such embodiments, static message channels (e.g., as defined by a hypervisor or other controller) reduce the risk of faulty context change requests. When the context transfer is completed, a second DSP 214B operating in context B may receive the message (now in context B) from messaging system 220. In some embodiments, DSP 214A and 214B are two different processors operating in two different contexts. In another embodiment, DSP 214A and 214B are a same processor, and the processor changes contexts (e.g., as directed by a controller) between the message send request and the message receive request.

In various embodiments, changing contexts may be useful to pass data between different functions in the system. For example, measurements in a device may be performed in a first context while data transfers (e.g., transmission/reception) may operate in a second context. In such embodiments, messaging system 220 may be used to transmit measurement data (e.g., channel quality) taken in the first context to data transfer operations running in the second context. In other embodiments, contexts of data may be changed for other reasons.

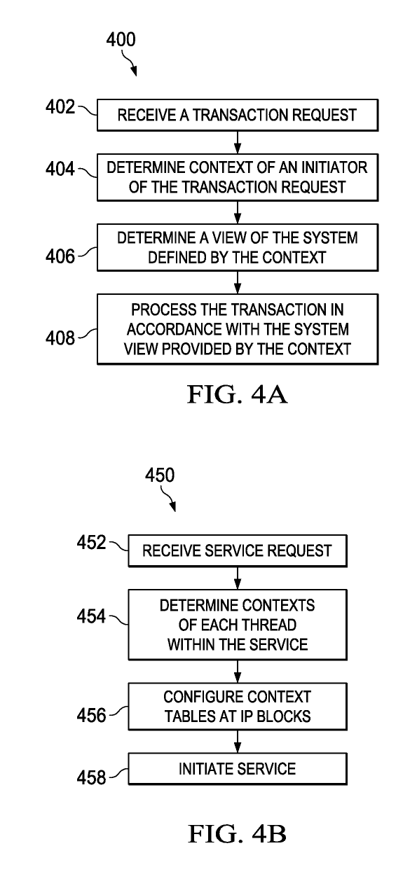

FIG. 4A illustrates an example process flow 300 of an IP Block (e.g., IP block 104) processing a transaction request within a context in accordance with some embodiments. In step 402, the IP block receives a transaction request. In step 404, the IP block determines a context corresponding to the transaction (e.g., a context of an initiator of the transaction request is running within). For example, the IP block may determine the context using a context ID transmitted with the transaction request. In step 406, the IP block determines a view of the computing system defined by the context. For example, the context may define system capabilities, resources, security, priority, combinations thereof and the like available to threads running within the context. In an embodiment, the IP block determines the system view be referencing a context table configured at the IP block by a controller (e.g., a hypervisor) prior to the IP block receiving the transaction request. In step 408, the IP block processes the transaction request in accordance with the system view provided by the context. For example, when the transaction request is permitted by the context, the IP block may fulfill the transaction request using the capabilities and resources defined by the context. In another example, when the transaction request is not permitted by the context, the IP block may alert the controller by transmitting an error, for example.

FIG. 4B illustrates an example process flow 450 of controller (e.g., hypervisor 102) operations in accordance with some embodiments. In step 452, the controller receives a service request including one or more threads. In step 454, the controller determines a context of each of the threads within the service. In step 456, the controller configures tables at IP blocks with a view of the computing system defined by each context in the service request. In some embodiments, the view of the computing system includes capabilities, resources, priority level, security, combinations thereof, and the like available to threads running within the context. In step 458, the controller initiates the service, for example by passing the threads to one or more processor(s) and configuring a user context register at the processor with a corresponding context ID. The processor may then execute the thread within the context, for example, by sending transaction requests to other IP blocks within the system. Each transaction request may be transmitted with a corresponding context ID, and the individual IP blocks may process the request in accordance with a view of the computing system defined by a respective context.

As described above, various embodiments implement contexts within a heterogeneous, real-time environment in order to provide isolation and virtualization of different processes run by a computing system (e.g., system 100). Contexts define a specific view of the system to threads running within the context. For example, a context may define the available resources, capability, priority, protection, combinations thereof and the like available to threads running within the context. Various IP blocks in a system process threads in the thread's context. When an IP block receives a transaction request, an indicator (e.g., a context ID) is transmitted to indicate a context of an initiator of the request. The IP block may inherit the context of the initiator, and using the system view defined by the context, the IP block determines the functionality, priority, resources, protection, and/or the like available to process the requested transaction. Information may be passed between contexts through static messaging channels. Thus, resource management and access permissions may be enforced by individual IP blocks within the system, which provides an efficient, real-time mechanism for visualization and isolation of embedded processing resources.

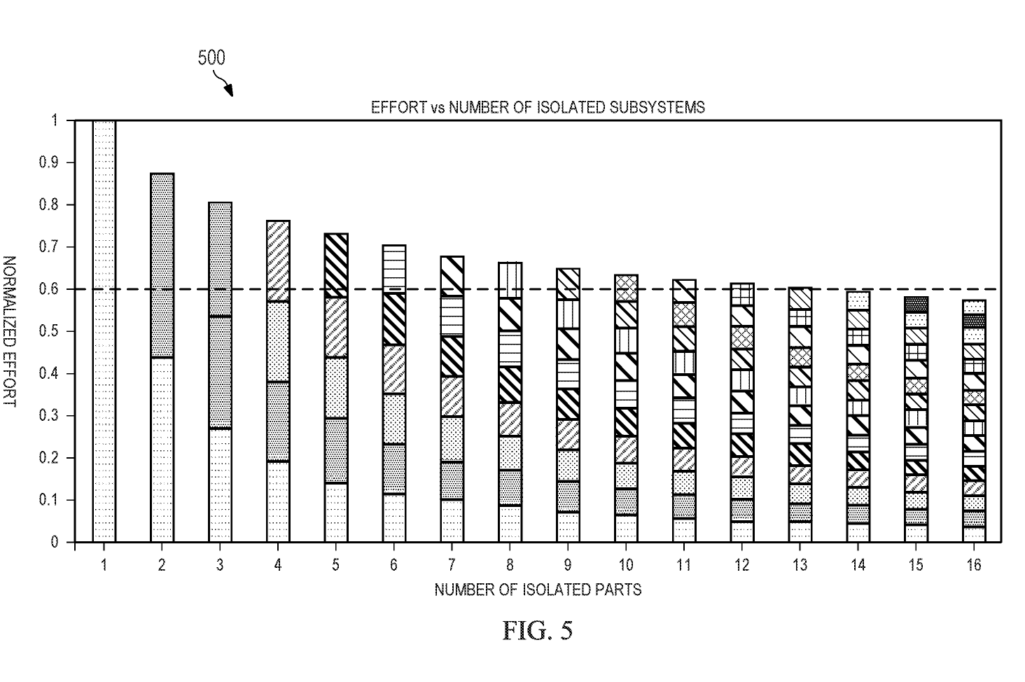

It has further been observed that by implementing the embodiments described above, isolation can be implemented in a system to reduce software effort as illustrated by graph 500 of FIG. 5. In FIG. 5, normalized software effort is plotted on the y-axis while the number of isolated subsystems is plotted on the x-axis for an example simulation of an embodiment. As illustrated, implementing as few as fourteen isolated parts within the system produced savings of more than 40%. The reduced software effort may be achieved, at least in part, by a reduction of interactions between IP blocks and a controller. For example, IP blocks may enforce contexts with reduced controller input because IP blocks can determine what resources/capabilities to offer threads without requesting controller input for every transaction.

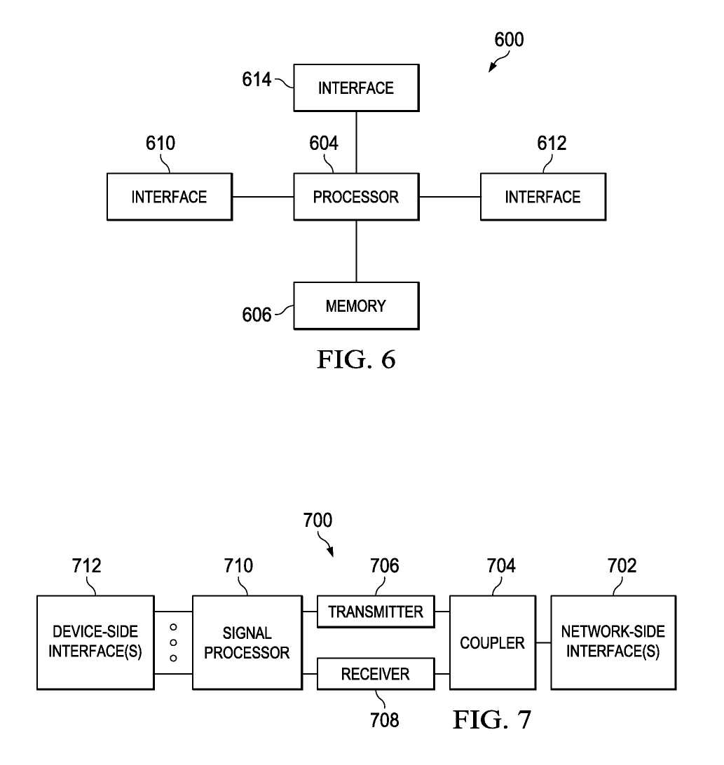

FIG. 6 illustrates a block diagram of an embodiment processing system 600 for performing methods described herein, which may be installed in a host device or individual IP blocks. As shown, the processing system 600 includes a processor 604, a memory 606, and interfaces 610-614, which may (or may not) be arranged as shown in FIG. 6. The processor 604 may be any component or collection of components adapted to perform computations and/or other processing related tasks, and the memory 606 may be any component or collection of components adapted to store programming and/or instructions for execution by the processor 604. In an embodiment, the memory 606 includes a non-transitory computer readable medium. In an embodiment, the processor 604 includes processing circuitry at an IP block within the system to enforce contexts as described above, and the memory 606 includes memory at the IP block to store context-related information (e.g., context ID, context tables, and the like) as described above. The interfaces 610, 612, 614 may be any component or collection of components that allow the processing system 600 to communicate with other devices/components and/or a user. For example, one or more of the interfaces 610, 612, 614 may be adapted to communicate data, control, or management messages from the processor 604 to applications installed on the host device and/or a remote device. As another example, one or more of the interfaces 610, 612, 614 may be adapted to allow a user or user device (e.g., personal computer (PC), etc.) to interact/communicate with the processing system 600. The processing system 600 may include additional components not depicted in FIG. 6, such as long term storage (e.g., non-volatile memory, etc.).

In some embodiments, the processing system 600 is included in a network device that is accessing, or part otherwise of, a telecommunications network. In one example, the processing system 600 is in a network-side device in a wireless or wireline telecommunications network, such as a base station, a relay station, a scheduler, a controller, a gateway, a router, an applications server, or any other device in the telecommunications network. In other embodiments, the processing system 600 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 610, 612, 614 connects the processing system 600 to a transceiver adapted to transmit and receive signaling over the telecommunications network. FIG. 7 illustrates a block diagram of a transceiver 700 adapted to transmit and receive signaling over a telecommunications network. The transceiver 700 may be installed in a host device. As shown, the transceiver 700 comprises a network-side interface 702, a coupler 704, a transmitter 706, a receiver 708, a signal processor 710, and a device-side interface 712. The network-side interface 702 may include any component or collection of components adapted to transmit or receive signaling over a wireless or wireline telecommunications network. The coupler 704 may include any component or collection of components adapted to facilitate bi-directional communication over the network-side interface 702. The transmitter 706 may include any component or collection of components (e.g., up-converter, power amplifier, etc.) adapted to convert a baseband signal into a modulated carrier signal suitable for transmission over the network-side interface 702. The receiver 708 may include any component or collection of components (e.g., down-converter, low noise amplifier, etc.) adapted to convert a carrier signal received over the network-side interface 702 into a baseband signal. The signal processor 710 may include any component or collection of components adapted to convert a baseband signal into a data signal suitable for communication over the device-side interface(s) 712, or vice-versa. The device-side interface(s) 712 may include any component or collection of components adapted to communicate data-signals between the signal processor 710 and components within the host device (e.g., the processing system 600, local area network (LAN) ports, etc.).

The transceiver 700 may transmit and receive signaling over any type of communications medium. In some embodiments, the transceiver 700 transmits and receives signaling over a wireless medium. For example, the transceiver 700 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 702 comprises one or more antenna/radiating elements. For example, the network-side interface 702 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 700 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

1. A method comprising:
receiving, by an intellectual property (IP) block within a computing system, a transaction request;
determining, by the IP block, a context corresponding to the transaction request;
determining, by the IP block, a view of the computing system defined by the context; and
processing, by the IP block, the transaction request in accordance with the view of the computing system defined by the context.

2. The method of claim 1, wherein determining, by the IP block, the context comprises receiving, by the IP block, a context identifier (ID) with the transaction request.

3. The method of claim 1, wherein determining, by the IP block, the view of the computing system defined by the context comprises referencing a context table, at the IP block, comprising the view of the computing system defined by the context.

4. The method of claim 3 further comprising receiving, by the IP block, context table configurations from a controller prior to receiving the transaction request.

5. The method of claim 1, wherein the view defined by the context comprises capabilities, resources, priorities, protections, or a combination thereof available to threads running within the context.

6. The method of claim 1, wherein processing, by the IP block, the transaction request comprises fulfilling the transaction request using resources in the view of the computing system defined by the context when the transaction request is permitted in the view of the computing system defined by the context.

7. The method of claim 1, wherein processing, by the IP block, the transaction request comprises transmitting an error to a controller when the transaction request is not permitted in the view of the computing system defined by the context.

8. The method of claim 1, wherein determining, by the IP block, the context comprises receiving, by the IP block, a context identifier (ID) with the transaction request, and wherein the method further comprises transmitting, by the IP block, an additional transaction request and the context ID to an additional IP block, wherein the additional transaction request is in accordance with the transaction request.

9. An intellectual property (IP) block comprising:
processing circuitry; and
a computer readable storage medium storing programming for execution by the processing circuitry, the programming including instructions to:
receive a transaction request;
receive a context identifier (ID) of a context corresponding to the transaction request;
determine a system view defined by the context; and
process the transaction request in accordance with the system view defined by the context.

10. The IP block of claim 9, wherein the system view defined by the context comprises capabilities, resources, priorities, protections, or a combination thereof available to threads running within the context.

11. The IP block of claim 9, wherein the instructions to determine the system view defined by the context comprises instructions to reference a context table comprising the system view defined by the context, wherein the context table is stored at the IP block.

12. The IP block of claim 11, wherein the context table is configured by a hypervisor.

13. The IP block of claim 11, wherein an initiator of the transaction request is operating within the context when the transaction request is transmitted.

14. A method comprising:
receiving, by a controller in a computing system, a service request comprising a thread;
determining, by the controller, a context for the thread;
configuring, by the controller, a view of the computing system defined by the context on a respective context table at each of a plurality of intellectual property (IP) blocks in the computing system; and
after configuring, by the controller, the view of the computing system defined by the context, initiating a service corresponding to the service request.

15. The method of claim 14 further comprising:
receiving, by the controller, an error regarding the thread from a first one of the plurality of IP blocks, wherein the error indicates an invalid transaction request;
updating, by the controller, a context table at the first one of the plurality of IP blocks if the view of the computing system defined by the context permits the invalid transaction request; and
terminating, by the controller, the thread if the view of the computing system defined by the context does not permit the invalid transaction request.

16. The method of claim 15, wherein initiating the service comprises:
passing the thread to a processor; and
storing a context identifier (ID) in a user context register at the processor.

17. The method of claim 15, wherein the view of the computing system defined by the context comprises capabilities, resources, priorities, protections, or a combination thereof available to the thread.

18. The method of claim 15, wherein the computing system further comprises a messaging system, wherein:
receiving, by the messaging system, a message in a first context; and
transmitting, by the messaging system, the message in a second context different than the first context.

19. A controller comprising:
a processor; and
a computer readable storage medium storing programming for execution by the processor, the programming including instructions to:
receive a service request comprising a thread;
determine a context for the thread;
configure a system view defined by the context on a respective context table at each of a plurality of intellectual property (IP) blocks; and
after configuring the system view defined by the context, initiate a service corresponding to the service request.

20. The controller of claim 19, wherein the system view defined by the context comprises capabilities, resources, priorities, protections, or a combination thereof available to the thread.
